(19) United States
(12) Patent Application Publication
(10) Pub. No.: US 2016/0208542 A1
(43) Pub. Date: Jul. 21, 2016

(54) Concealed Weapons Security Cabinet

(71) Applicant: Mark Andrew Coons, Modesto, CA (US)

(72) Inventor: Mark Andrew Coons, Modesto, CA (US)

(21) Appl. No.: 14/599,505

(22) Filed: Jan. 17, 2015

(51) Int. Cl. E05G 1/00; A47B 81/00; E05B 65/00; E05G 1/026; E05G 1/04

(52) U.S. Cl. CPC E05G 1/005; E05G 1/026; E05G 1/04; E05B 65/0075; A47B 81/005; E05G 2700/02

(57) ABSTRACT

A locking, concealed weapons storage cabinet designed to offer secure storage of home defense weapons. Weapons are readily available to the home owner but still secured to prevent unauthorized access. Cabinet is concealed as a piece of artwork that is either stand-alone or part of a group of artwork pieces or other ornamental pieces. Cabinet allows rapid access in regular or low light conditions.

### CROSS-REFERENCE TO RELATED APPLICATIONS

The application claims benefit of U.S. Provisional Application No. 61/928,659 entitled “Instant Access IPS” and filed on Jan. 17, 2014, which is specifically incorporated by reference herein for all that it teaches and discloses

### BACKGROUND

### Prior Art

The following is a tabulation of some prior art that presently appears relevant:

US Patents

| Patent Number | Kind Code | Filing Date | Issue Date | Patentee(s) |
|---|---|---|---|---|
| 20120206026 | A1 | Feb. 16, 2012 | Aug. 16, 2012 | Emelio, Fred |
| 7,178,370 | B2 | Nov. 29, 2004 | Feb. 20, 2007 | Engel, Raymond C |
| 6,363,760 | B1 | Sep. 15, 1999 | Apr. 2, 2002 | Sigmond, Edward |
| 4,304,447 | A | Jul. 18, 1980 | Dec. 8, 1981 | Ellwood/Hoffman |

### Nonpatent Literature Documents

Stackon, FULL-LENGTH IN-WALL STEEL CABINET. (2012). Retrieved from https://www.stack-on.com/categories/security-cabinets-gun-cabinets/products/75

TacticalWalls, Concealment Covers and Inserts. (2012, October). Retrieved from http://tacticalwalls.com/product-category/concealment-covers/

Gun safety is of paramount importance in our country because of the many guns owned by Americans. Pew research estimates there is somewhere between 270 million and 310 million privately owned guns. A significant number of these weapons are owned for self-defense inside the home. A growing market segment for home defense weapons are the home defense shotgun which incorporates a shorter barrel than sporting models as well as the semi-automatic carbine such as the AR-15. More than 400,000 home defense shotguns are sold in the US each year according to the Bureau of Alcohol, Tobacco, and Firearms.

Responsible gun owners keep these weapons secured. The most common security measures are either in a gun safe or various styles of gun locks. The problem with these type of security is excessive access time. Each of the options requires the gun owner to turn on the light or at least a flash light, put in a combination or find and put in a key, remove the weapon from the safe or remove the locking device from the weapon and then proceed to defend their life and property.

According to the FBI there were nearly 60,000 home invasions (ROBBERY WITHIN A RESIDENCE) in 2012. These incidents often unfold very rapidly. Nearly every gun owner knows that in emergent situations seconds count, and the above described security options take numerous minutes to access the owner's home defense weapon. Unfortunately, many gun owners find this access time too great and make the irresponsible decision to leave their home defense weapon both loaded and unsecured. This has led to many, many, injuries and deaths when these weapons fall into the hands of children or the untrained.

Additionally, the presence of a gun safe or a weapon that is secured but left in the open creates a number of problems. It is not aesthetically pleasing to many people. It attracts attention to the presence of a weapon or other valuables and thus makes them obvious targets for thieves. This obviousness will also lead home invaders to immediately block access to these weapons during a home invasion. It can also pique the interest of children and lead them to attempt to access the weapon when the adults are away.

Accordingly there is a well-defined need for a secured, aesthetically pleasing, readily accessible, concealed, locking home defense weapons cabinet. While a number of the items that are either being marketed or are patented as outlined in the referenced prior art, none of them quite fill all of the needs identified here. Patent 20120206026 as well as the TacticalWalls product both require a magnetic key fob which is easily lost or is not readily acceptable. The Stackon product also uses a key and does nothing to conceal the storage solution. U.S. Pat. Nos. 7,178,370 and 6,363,760 lack both concealment as well an aesthetically pleasing appearance and are generally designed for handguns. U.S. Pat. No. 4,304,447 does not lock and is not of sufficient size to accommodate home defense long guns.

### SUMMARY

In accordance with one embodiment a security cabinet with door of sufficient size that it will fit between the studs in common home construction and of sufficient depth such that the cabinet will fit inside the walls common to home construction. Cabinet and security door are constructed of high strength material such that they will resist attempts to gain unauthorized access. The security door connects to the cabinet via a continuous hinge. The locking mechanism in this embodiment is through to electronic solenoids placed on the interior of the security door. Solenoids are actuated by the microprocessor and associated componentry on the printed circuit board. The printed circuit board is mounted to the exterior surface of the security cabinet door. A piece of art or other ornamental device is connected to the security door via another continuous hinge. Concealed in the art frame is the combination input keypad. The art covers the microprocessor and associated componentry and is securely locked to the security door via a keyed cylinder lock. When the user inputs the correct combination, the solenoids actuate and the artwork and security door pivot open allowing the user access to the home defense weapon secured inside. The input code is user programmable and the unit is powered by batteries, ac current, or a combination thereof. Units are offered a single or multiple panel artwork schemes with one or more working security cabinets.

### DRAWINGS—FIGURES

FIG. 1 is a perspective view of the security cabinet and its interior

FIG. 2 is a perspective view of the security cabinet installed between the studs of a typical wall

FIG. 3 is a front view of the security door and the components attached thereto

FIG. 4 is a perspective view of the artwork door

DRWAINGS - REFERENCE NUMERALS

| | | | |
|---|---|---|---|
| 1 | Cutout to accommodate | 2 | Solenoid latch cutout |
| | longer weapons | | |
| 3 | Mounting holes | 4 | Mounting hardware |
| | | | for weapon |
| 5 | Continuous hinge security | 6 | Wall studs |
| | door to cabinet | | |
| 7 | Keypad or biometric input | 8 | Electronic solenoid |
| 9 | Continuous hinge artwork | 10 | Microprocessor and |
| | to security door | | printed circuit |
| 11 | Cutout for cylinder lock cam | 12 | Power supply (AC or DC) |
| 13 | Keyed cylinder lock | 14 | Concealed Cabinet |

### DETAILED DESCRIPTION

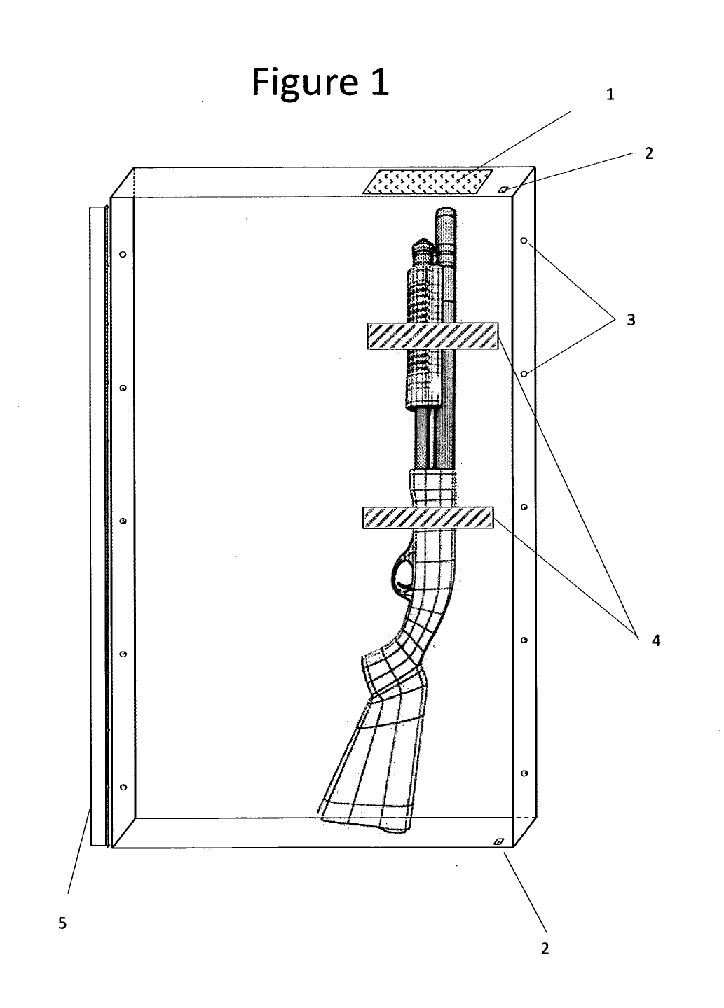

FIG. 1 illustrates the security cabinet in the first embodiment. It is of sufficient width that it will fit between the studs typical in home construction. It is of sufficient depth such that it will fit flush inside a typically constructed residential wall. Said cabinet is of sufficient length that it will accommodate the weapon or weapons for which it is designed. It is fabricated of high strength material such that it will resist attempts to gain unauthorized access. Said cabinet has a cutout 1 in the top of the case such that longer weapons may extend up through the opening into the stud cavity. Cabinet has solenoid latch cutouts 2 in the top and bottom to allow for the solenoid plungers to extend with the security door is closed thereby locking the security door securely closed. Mounting holes 3 accommodate screws which will mount the cabinet into the sides of the studs. Weapon mounting hardware 4 takes on various forms including hook and loop straps, magnets, pegs, and other such hardware that helps hold the weapon in a ready position. Said cabinet has a continuous hinge 5 that attached the security door to said cabinet.

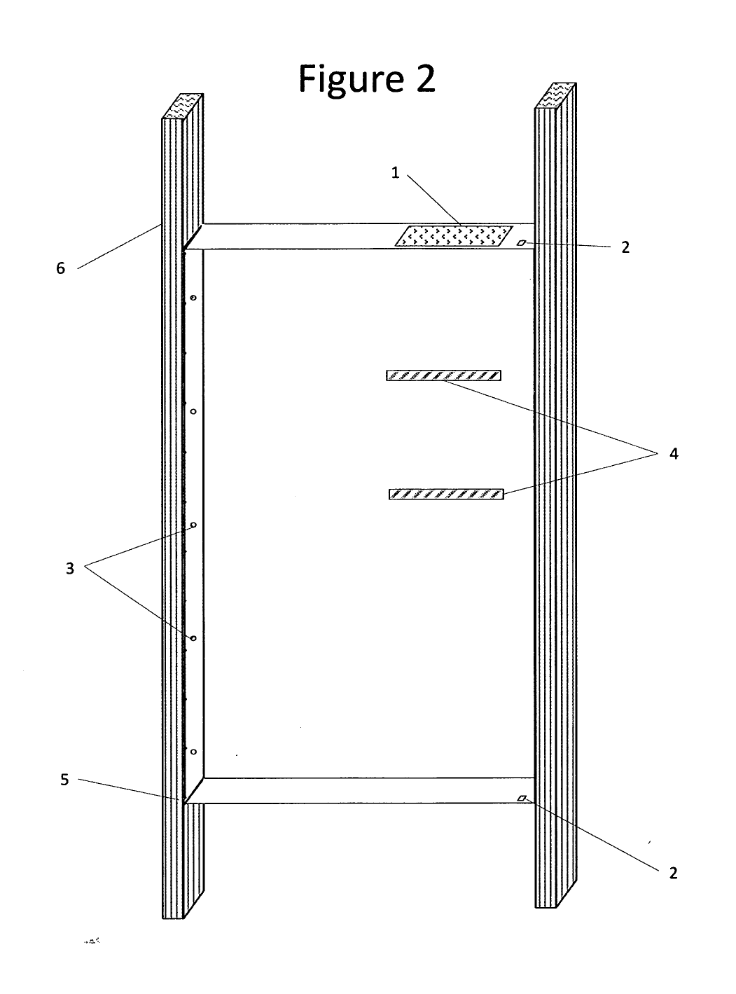

FIG. 2 illustrates the security cabinet installed into the stud cavity of a typical wall. Mechanical fasteners are placed through mounting holes 3 and fastened to the side of the studs 6. When installed, the knuckle continuous hinge 5 extends one knuckle length beyond the exterior of the wall surface (typically drywall) such that said knuckle rests on the exterior wall surface.

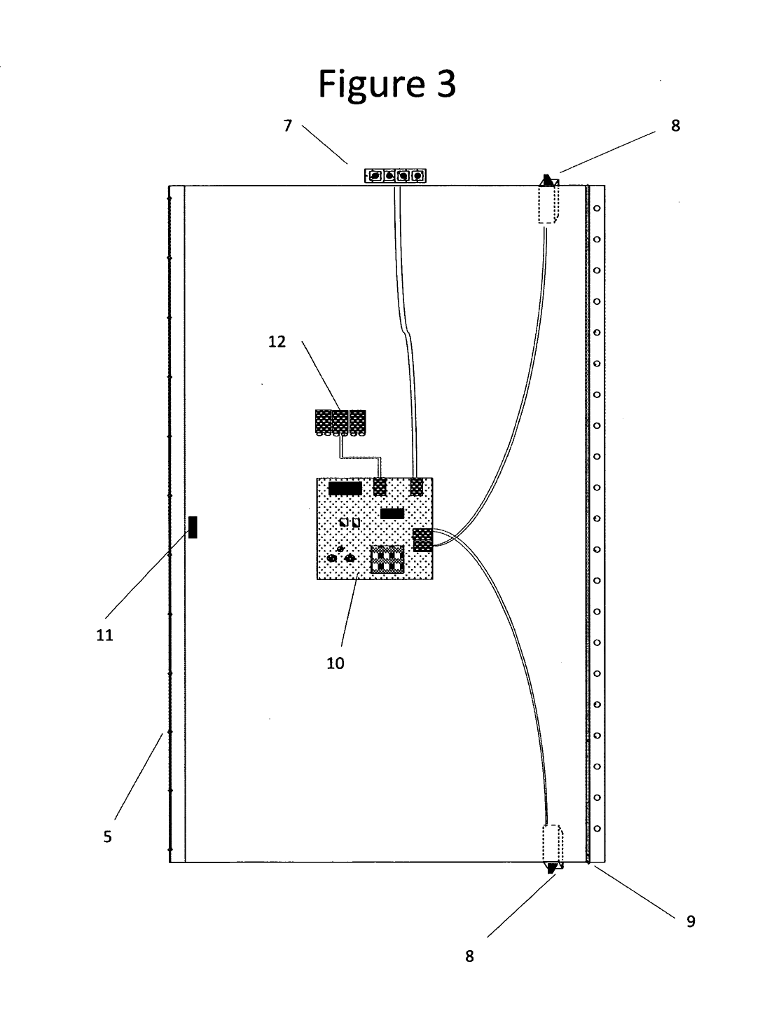

FIG. 3 illustrates the security door which is of sufficient width and length to completely cover the opening of the security cabinet. Said door is fabricated of high strength material such that it will resist attempts to gain unauthorized access. Continuous hinge 5 connects the door to the security cabinet. The electronic solenoids 8 are mounted to the inside of said door such that the solenoid plungers extend up the through the solenoid latch cutouts 2 in the security cabinet when the door is closed. The continuous hinge 9 connects the artwork door to the security door. The microprocessor and printed circuit 10 mounts to the surface of the security door, processes user inputs and actuates the solenoids 8 when the correct input signal is initiated. The input keypad or biometric input device 7 accepts the user input and transmits that to the microprocessor and printed circuit. The power supply 12 powers the printed circuitry. The door has a cylinder lock cam cutout 11 to accommodate the cylinder lock 13 in the artwork frame allowing the artwork to be securely latched to the security door.

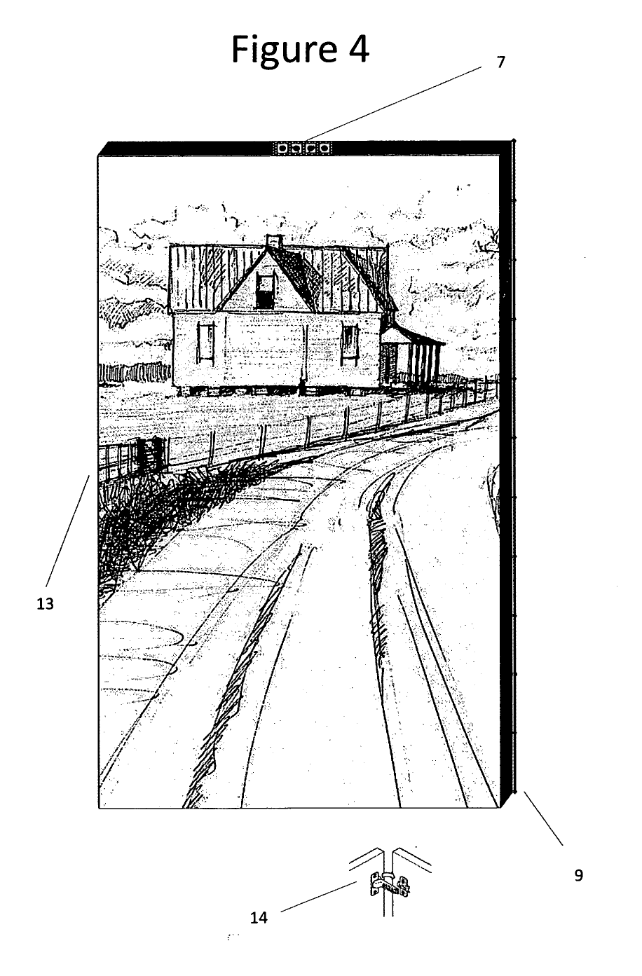

FIG. 4 illustrates a perspective view of the artwork door. The continuous hinge 9 connects the artwork door to the security cabinet door. The input keypad or biometric sensor 7 is secreted into the frame of the art such that it is not readily obvious but still accessible to the user. There is a keyed cylinder lock 13 secreted into the frame, typically under a canvas flap, such that the user can use a key to open the artwork door and access the power supply 12 and printed circuit 10.

### Operation

Once installed the user uses the keyed cylinder lock 13 to open the artwork door. The user then initiates the programming sequence on the printed circuit 10 and inputs there unique code. The printed circuit 10 acknowledges the input indicating for the user to proceed. The artwork door is closed and the keyed cylinder lock 13 locked. The user then inputs the previously programmed unique input into the keypad or biometric sensor 7. The microprocessor 10 analyzes the input and initiates the opening sequence if the input matches the previously programmed input. The power is then supplied to the solenoids 8 which retract the plungers allowing both the security door (and attached artwork door) to pivot open. After a few seconds the power is shut off to the solenoids 8 and the solenoid plungers extend. The plungers are spring loaded and tapered such that the security door can be closed without actuating the solenoids. There is a voltage sensing circuit in the microprocessor 10 that audibly alerts the user to a low power condition.

### Alternative Embodiments

An additional embodiment uses concealed cabinet hinges 14 rather than the continuous hinges 9.

An additional embodiment has replaceable art panels that magnetically attach to the artwork door frame.

An additional embodiment has multiple pieces of artwork with one or more working security cabinet.

An additional embodiment used an RFID chip contained within a wearable device (ring, necklace, eyeglasses, etc) such that the input reads the RFID chip and opens the security door when the RFID is proximal to the sensor.

An additional embodiment uses a full length mirror in place of the artwork.

1. A concealed, rapidly accessed, locking cabinet for housing home defense weapons comprising:
a. A security cabinet of sufficient width that it will fit between the studs typical in home construction, of sufficient depth such that it will fit flush inside a typically constructed residential wall, of sufficient length that it will accommodate the weapon or weapons for which it is designed, fabricated of high strength material such that it will resist attempts to gain unauthorized access. Said cabinet mounted inside the stud cavity of a typical residential wall.
b. Multiple attachments including magnets, straps, pegs and other devices to mount the home defense weapon securely in said cabinet.
c. A security door attached to said cabinet of sufficient width and length to completely cover the opening of said security cabinet. Said door is fabricated of high strength material such that it will resist attempts to gain unauthorized access.
d. A hinged means of connecting said security door to said security cabinet.
e. A locking mechanism normally effective of securing said security door to said security cabinet operated by user input to a biometric input device or electronic keypad.
f. A microprocessor and associated circuitry capable of being programmed by an end user to accept a unique input and operate said locking mechanism.
g. An artwork or other ornamental door secured to said security door capable of housing electronics package, power supply, and secretly housing said input device.
h. A locking mechanism normally effective for securing said artwork door to said security door.

2. A concealed security cabinet according to claim 1 wherein said artwork door has replaceable panels.

3. A concealed security cabinet according to claim 1 wherein multiple pieces of artwork are combined to complete a common themed composition with one or more working security cabinets behind said pieces of art.

4. A concealed security cabinet according to claim 1 wherein said artwork door is replaced with a mirrored door

5. A concealed security cabinet according to claim 1 wherein the power source is either DC or AC or a combination thereof.

6. A concealed security cabinet according to claim 1 wherein said user input can also be and RFID chip and sensor combination.
